(19) United States
(12) Patent Application Publication
(10) Pub. No.: US 2007/0093123 A1
(43) Pub. Date: Apr. 26, 2007

(54) Journal printer data interrupt cable for real time data capture at the keystroke and scan level

(75) Inventor: David Gary Thomas SR., Madison, AL (US)

Correspondence Address: Mr. David Gary Thomas Sr., 149 Magnum Lane, Madison, AL, 35758, US

(73) Assignee: ezMiner, Inc., Madison, AL (US)

(21) Appl. No.: 11/255,255

(22) Filed: Oct. 21, 2005

(51) Int. Cl. H01R 12/24

(52) U.S. Cl. 439/498

(57) ABSTRACT

An electrical data connection device characterized by multiple connection points for intercepting and redirecting data flow. Connection points are characterized by an arrangement of male or female contact members and receptacles which separably connect to data generating and data receiving units.

The present invention pertains to data connection devices. More specifically, the invention pertains to an electrical data connection device that includes multiple connectors to intercept and retransmit data.

The invention is used for the replication and redirection of data transmitting between a cash register and a cash register journal printer, specifically an Epson TM-U950 type Model M62UA combination receipt and journal printer.

### BACKGROUND OF THE INVENTION

The invention allows for interception of real time data and the transmission of the data to other software packages.

It is therefore the object of the invention to capture transaction and item level detail, at that moment, every time an item's UPC code is scanned or a key is pressed.

It is another object of the invention to capture transaction and item level detail together.

It is another object of this invention to provide instantaneous, unprompted two-way communications sessions between the software and the cash register for the addition of items, price changes, and promo price end date and time and quantity thresholds.

### SUMMARY OF THE INVENTION

In accordance with the present invention, there is provided a real time interface that receives and transmits data between devices as the transaction is occurring. Data are captured as it flows from the cash register to the journal printer and redirected for use at the computer.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a complete real time data capturing system. It includes a cash register 3 with Epson TM-U950 type Model M62UA combination receipt and journal printer 2, a journal printer data interrupt cable 1, a data transmission cable 4 and a computer 5. This drawing is not to scale.

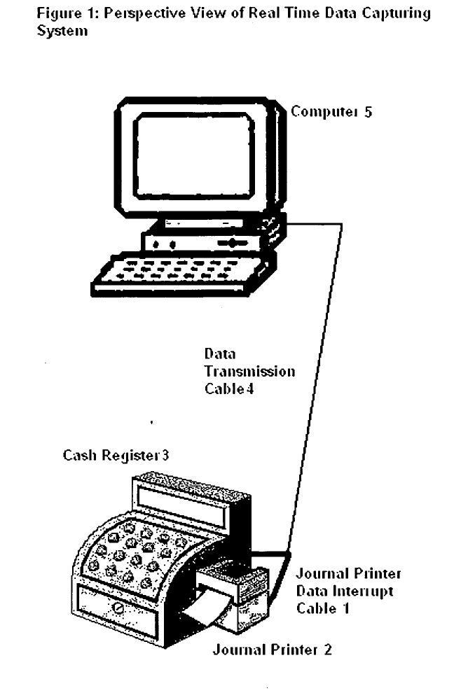

FIG. 2 is a front view of a journal printer data interrupt cable 1. It is composed of a cable and connectors used to intercept data that comes from the cash register 3. This cable sends the data to two places: the cash register's journal printer 2 and the data transmission cable 4, which connects to the computer 5 recording the transaction. This cable is normally 18 inches long.

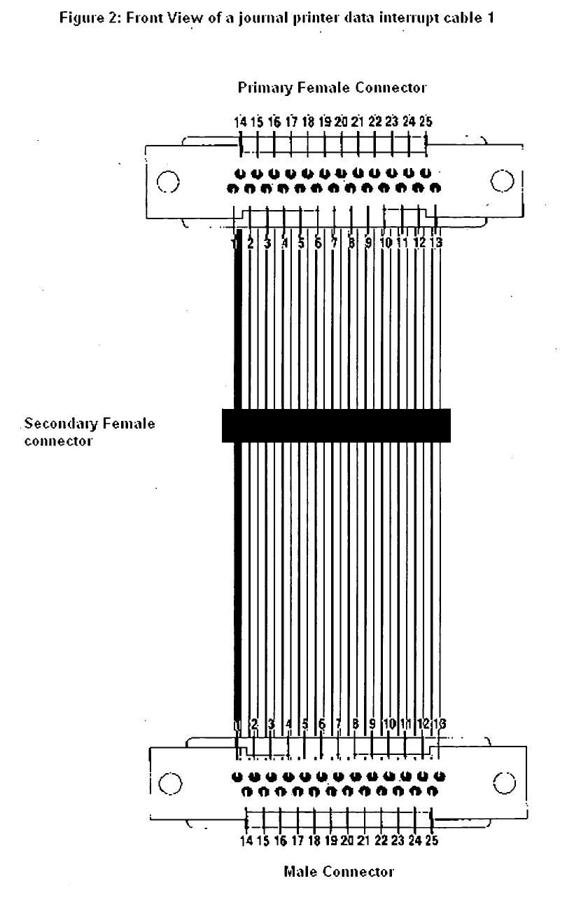

FIG. 3 is a rear view of a journal printer data interrupt cable 1. It is composed of a cable and connectors used to intercept data that comes from the cash register 3. This cable sends the data to two places: the cash register's journal printer 2 and the data transmission cable 4, which connects to the computer 5 recording the transaction. This cable is normally 18 inches long.

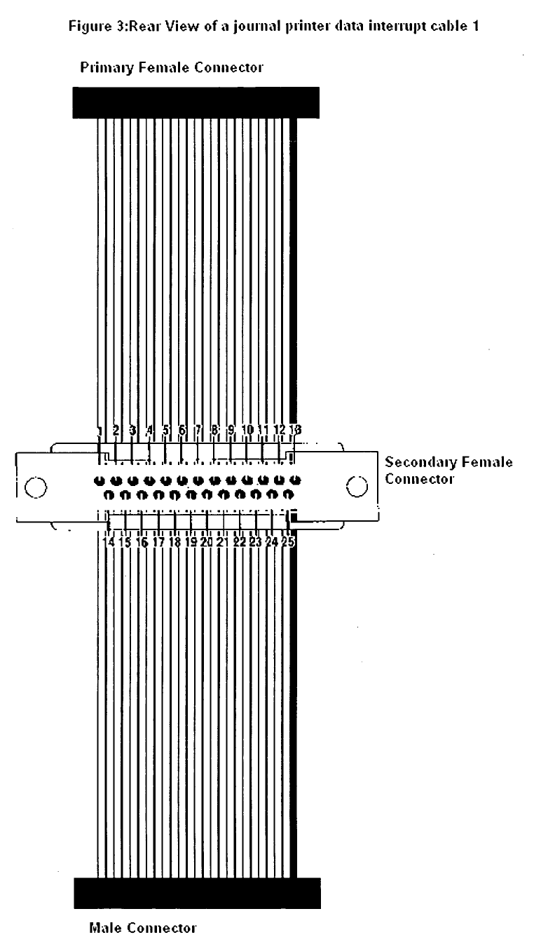

For purposes of clarity and brevity, like elements and components will bear the same designations and numbering throughout the figures.

Since other modifications and changes may vary to fit particular operating environments and requirements, such as the different types of computer, cash register or data transmission cable, which will be apparent to those skilled in the technology, the invention is not considered limited to the example chosen for purposes of disclosure, and covers all changes and modifications which do not constitute departures from the true spirit and scope of this invention. Variances may include but are not limited to the numbers of male contact members and female contact member receptacles in each connector, the number of spaced and insulated passageways and contained electrical data conductors, or length of said passageways and contained electrical data conductors.

Having thus described the invention, what is desired to be protected by Letters Patent is presented in the subsequently appended claims.

What is claimed is:

1. An electrical data transmission cable for capturing real-time transaction data at the UPC scan and keystroke level for sales and cashier data from an Epson TM-U950 type Model M62UA printer and transmitting said data to a computer.

2. A component being the cable specified in claim 1, comprising a receptacle body, with said body being defined by top and bottom walls, and side boundaries, containing individual electrical data conductors through a plurality of spaced and insulated passageways, terminating at one end in a connector comprised of male contact members capable of inserting into a like-configured female contact member receptacle and terminating at the opposite end in a connector comprised of female contact member receptacles capable of accepting like-configured male contact members, and having an secondary set of female contact member receptacles positioned mid-way.

3. A component being the cable recited in claim 2 wherein said body is fabricated from an insulative material.

4. A component being the cable recited in claim 2 wherein said plurality of spaced and insulated passageways is oriented in said body in parallel rows.

5. A component being the cable recited in claim 2 wherein said plurality of spaced and insulated passageways each contains a single electrical data conductor.

6. A component being the cable recited in claim 2 wherein said male contact members are arranged in a pattern so as to be associated with a correspondingly arranged set of female contact member receptacles.

7. A component being the cable recited in claim 2 wherein said female contact member receptacles are arranged in a pattern so as to be associated with a correspondingly arranged set of male contact members.

8. A component being the cable recited in claim 2 wherein said secondary set of female contact member receptacles positioned mid-way on the cable are arranged in a pattern so as to be associated with a correspondingly arranged set of male contact members.

9. A component being the cable recited in claim 2 wherein said additional set of female contact member receptacles positioned mid-ways is situated in such a way that it faces the opposite direction than both the male contact members described in claim 6 and the female contact member receptacles described in claim 7.

10. Properties of the member receptacles specified in claims 6, 7 and 8 may differ to be a male instead of female or female instead of male, depending on specific operating requirements.
